(19) United States
(12) Patent Application Publication
(10) Pub. No.: US 2019/0334387 A1
(43) Pub. Date: Oct. 31, 2019

(54) PROXIMITY BASED WIRELESS POWER TRANSMISSION MODIFICATION

(71) Applicant: Ossia Inc., Bellevue, WA (US)

(72) Inventor: Philip L. Swan, Redmond, WA (US)

(21) Appl. No.: 15/967,509

(22) Filed: Apr. 30, 2018

(51) Int. Cl. H02J 50/60; H02J 50/20; H02J 50/80

(52) U.S. Cl. CPC H02J 50/60; H02J 50/80; H02J 50/20

(57) ABSTRACT

Proximity based wireless power transmission modification is disclosed. A proximity of an object to a region of higher energy density associated with wireless transmission of power can be determined. Based on the proximity, wireless power transmission can be modified. Modification can include suspending transmission, initiating transmission, increasing transmission power, decreasing transmission power, or changing a distribution of transmitted energy of the region. The modification of the wireless power transmission can change, based on the proximity of the object to the region that is the target of the wireless power transmission, an amount of exposure to energy encountered by the object. A characteristic of the object can also be determined and employed in determining the modification of the wireless power transmission.

### TECHNICAL FIELD

The disclosed subject matter relates to wireless power transmission. In an embodiment, wireless power transmission can be adapted based on a proximity, distance, etc., of an object to a device that receives a transmission providing wireless power.

### BACKGROUND

By way of brief background, conventional wireless power transmission can allow a receiving device to receive power that is transmitted wirelessly to the receiving device. Wireless power transmission can cause a higher energy density in a region. A receiving device in that higher energy density region can harvest power from the higher energy density, e.g., a phone can charge wirelessly when placed in a region of higher energy density caused by transmission of radio frequency (RF) energy to the region. In an aspect, where the object is living tissue, the higher energy density field can be regulated by, for example, government agencies. Moreover, the higher energy density can affect both living and non-living objects, either directly or indirectly. As an example, a higher energy density in a region can be associated with a corresponding direct generation of heat, such as where microwave energy is directed at an area, etc. As another example, a higher energy density in a region can cause indirect effects, such as where a smartphone uses the higher energy density in an area to charge the smartphone, the smartphone can generate heat as part of the charging of the smartphone, which can be an indirect effect of the higher energy density in the area.

### BRIEF DESCRIPTION OF DRAWINGS

FIG. 1 is an illustration of an example system that can enable adaptation of wireless power transmission based on a proximity of an object to an area of higher energy density, in accordance with aspects of the subject disclosure.

FIG. 2 is an illustration of an example system that can facilitate adaptation of wireless power transmission based on a proximity of living tissue to a region of higher energy density, in accordance with aspects of the subject disclosure.

FIG. 3 is an illustration of an example system that can enable modification of wireless power transmission based on a spatial relationship of an object to one or more areas of higher energy density, in accordance with aspects of the subject disclosure.

FIG. 4 an illustration of an example system that can enable altering wireless power transmission based on distances of objects to one or more areas of higher energy density, in accordance with aspects of the subject disclosure.

FIG. 5 an illustration of an example system that can enable adaptation of wireless power transmission based on a proximity of an object to an area of higher energy density and based on a characteristic of the object, in accordance with aspects of the subject disclosure.

FIG. 6 is an illustration of an example method enabling adaptation of wireless power transmission based on a proximity of an object to an area of higher energy density, in accordance with aspects of the subject disclosure.

FIG. 7 illustrates an example method enabling adaptation of wireless power transmission based on a characteristic of an object and based on a proximity of an object to an area of higher energy density, in accordance with aspects of the subject disclosure.

FIG. 8 illustrates an example method facilitating adaptation of wireless power transmission based on a rule related to a safety level for living tissue having a proximity to an area of higher energy density, in accordance with aspects of the subject disclosure.

FIG. 9 depicts a block diagram of an example wireless power delivery environment illustrating wireless power delivery from one or more wireless power transmission systems to various wireless devices within the wireless power delivery environment, in accordance with various example embodiments;

FIG. 10 depicts a sequence diagram illustrating example operations between a wireless power transmission system and a wireless receiver client for commencing wireless power delivery, in accordance with various example embodiments;

FIG. 11 depicts a block diagram illustrating example components of a wireless power transmission system, in accordance with various example embodiments;

FIG. 12 depicts a block diagram illustrating example components of a wireless power receiver client, in accordance with various example embodiments;

FIGS. 13A and 13B depict block diagrams illustrating example multipath wireless power delivery environments, in accordance with various example embodiments;

FIG. 14 depicts a block diagram illustrating example components of a representative mobile device or tablet computer with a wireless power receiver or client in the form of a mobile (or smart) phone or tablet computer device, in accordance with various example embodiments; and

FIG. 15 depicts a diagrammatic representation of a machine, in an example form, of a computer system within which a set of instructions, for causing the machine to perform any one or more of the methodologies discussed herein, may be executed, in accordance with various example embodiments.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional wireless power transmission typically allows a receiving device to receive power that is wirelessly directed to the receiving device. Wireless power transmission can cause a higher energy density in a region, and a receiving device in that region can generate power from the higher energy density, e.g., a video game controller can charge wirelessly when placed in a region of higher energy density caused by transmission of electromagnetic energy to the region. In an aspect, where the object is living tissue, the higher energy density field can be regulated by, for example, government agencies. Moreover, the higher energy density can affect both living and non-living objects, either directly or indirectly. As an example, a higher energy density in a region can be associated with a corresponding direct generation of heat in skin, such as where millimeter-wave energy is directed at an area occupied by people, etc. As another example, a higher energy density in a region can cause indirect effects, such as where a laptop computer uses the higher energy density in an area to charge, this can generate heat as part of the charging of the laptop battery, which can be an indirect effect of the higher energy density in the area. Conventional wireless charging can be associated with localized creation of a higher energy density region, e.g., a wireless charging ‘pad’ can generate a higher energy density region proximate to the pad, such that when a device is placed on the pad, the device can absorb a portion of the higher energy density in the localized area for power of the device, etc. In this example, the higher energy density region is typically small and proximate to the pad, such that adaptation of the wireless power transmission is less likely to affect other objects due to shielding in the pad, position of the pad relative to other objects (e.g., a pad on a nightstand can be less likely to affect a person sleeping in bed in comparison to creating the higher energy density region under the pillow of the person in the bed, etc.), the technology used to generate the higher energy density region, etc.

Where wireless power transmission is evolving and can create a higher energy density area at nearly any place in a space, there can be an increased chance that the higher energy density area can be proximate to an object that can be affected by the direct or indirect effects of the higher energy density area. As an example, a higher energy density area can be caused under a pillow, such as where a person places their phone under their pillow at night, to allow charging the phone while the user is in bed. It can be desirable to adjust the transmission of wireless power to the phone under the pillow where there may be concern for exposing the person's head to the electromagnetic field associated with the higher energy density area. In some instances, governments even regulate an exposure level of different parts of the human body to electromagnetic energy. As such, it can be desirable to change, e.g., reduce power to, adapt the focus of, stop or suspend, etc., the higher energy density area when it is within a determined distance, e.g., proximate to, an object, such as a human head, hand, etc., pet, plant, etc., sensitive electronics, art, delicate finishes on furniture, etc.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

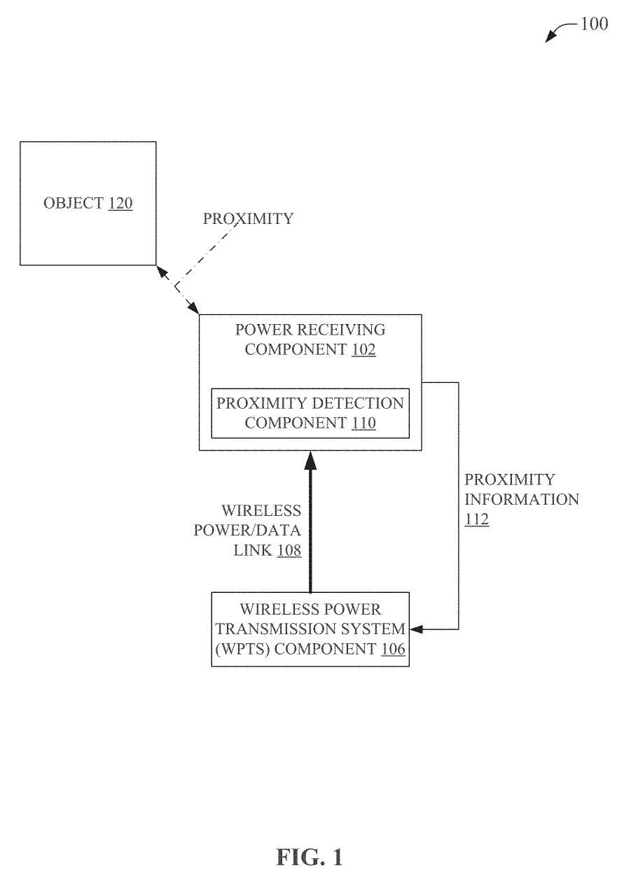

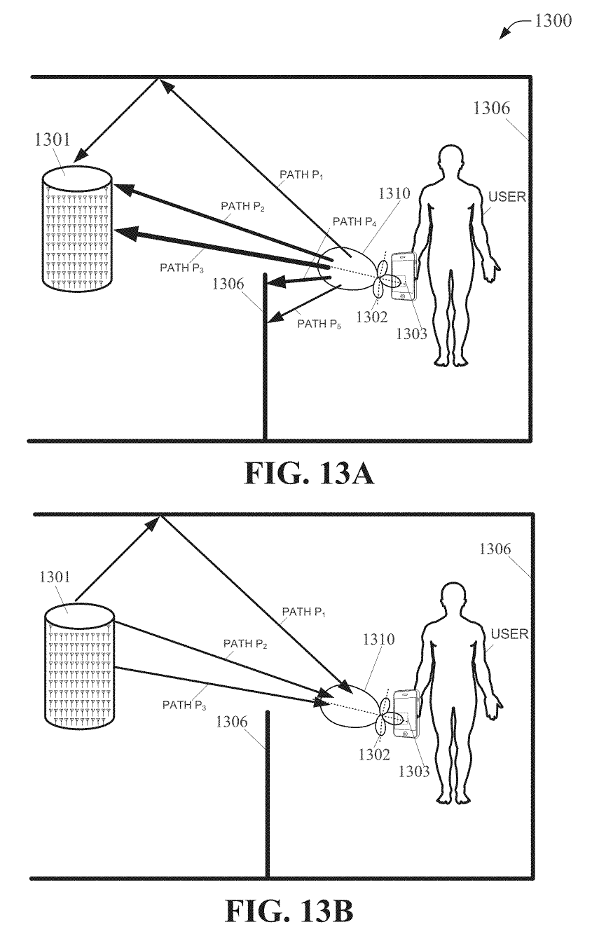

FIG. 1 is an illustration of a system 100 that can enable adaptation of wireless power transmission based on a proximity of an object to an area of higher energy density, in accordance with aspects of the subject disclosure. System 100 can comprise power receiving component 102. Power receiving component 102 can be, in some embodiments, comprised in a device such as a cellphone, laptop computer, game controller, television, clock, microwave, stereo equipment, vehicle, or nearly any other device that uses electrical power. In an aspect, power receiving component 102, can convert electromagnetic (EM) energy, or in fact any type of energy, e.g. acoustic energy, etc., into electricity that can be used, stored, etc. The electromagnetic energy can be radio frequency (RF) energy, for example, can be millimeter wave energy, microwave energy, 2.4 GHz energy, 800 MHz energy, 24 GHz energy, or nearly any other energy of the electromagnetic spectrum. In an aspect, transmitters of EM energy, e.g., wireless power transmission system (WPTS) component 106, 901A, 901B, etc., can be employed to cause a high energy density area, see FIG. 13B, etc. This high energy density area, in some embodiments, can be caused by constructive and/or destructive interference of EM waves in a region. The high energy density of an area can enable power receiving component 102 to ‘harvest’ the EM energy of the high energy density area for use as electrical energy, e.g., charging a phone, powering an internet of things (IOT) device, etc.

System 100 can further comprise WPTS component 106. WPTS component 106 can send wireless power. In an aspect, WPTS component 106 can send wireless power via wireless power/data link 108. Wireless power/data link 108 can cause an area of higher energy density, e.g., proximate to power receiving component 102, to enable power receiving component 102 to harvest the wireless energy, and receive any data sent via wireless power/data link 108, wirelessly.

In an embodiment, WPTS component 106 can receive proximity information 112. Proximity information 112 can indicate a proximity of an object, e.g., object 120, etc., to the area of higher energy density, which for simplicity of illustration in FIG. 1 can be substituted by an area proximate to power receiving component 102. In an aspect, higher power density at power receiving component 102 can enable harvesting of the energy for conversion to electrical energy. However, exposure of object 120 to the higher power density caused by wireless power/data link 108 can be undesirable. For example, where a cellphone is held to a user's ear, it can be undesirable to also create a higher energy density area at the user's head. In fact, EM fields near human body parts is often regulated by governmental organizations with limits set for ‘safe use’ based on a given density of the EM fields in relation to region of the human body. As such, where an object such as a human head is close to a higher energy density area, it can be desirable to change or suspend the higher energy density area, e.g., to meet governmental or other standards, best practices, etc. As an example, where a cellphone sits on a table, a first energy density for the area proximate to the phone can be acceptable, but as the cellphone is moved to the user's ear, it can be desirable to reduce the first energy density to a second energy density lower than the first energy density to reduce exposure of the user's head to the energy density associated with the first energy density. In some embodiments, it can be desirable to suspend transmission of wireless power when the example cellphone is within a determined proximity of the user's head. Similarly, adapting the wireless power supplied to the higher energy density area can be desirable for other body parts, e.g., the hand, the torso, the groin near the front pocket of pants, etc. Also, proximity to other objects can be employed to modify the wirelessly transmitted power into the higher energy density area, e.g., to reduce interference with sensitive electronics, to protect artwork or furniture, etc.

Proximity information 112 can be communicated from power receiving component 102, e.g., via proximity detection component 110. In an aspect, proximity detection component 110 can determine a proximity between power receiving component 102, part thereof, or an area of higher energy density associated with providing wireless power to power receiving component 102, etc., and object 120, e.g. via a power receiving component, such as 102, 202, 302, etc. As an example, movement of a device comprising power receiving component 102 can be detected by an accelerometer, which can be indicative, for some patterns of movement, of the device being held by a person, which in turn is indicative of power receiving device 102 being within a determined proximity of the person. As another example, a capacitive sensor can detect a change in the dielectric field proximate to power receiving component 102 that can be indicative of a cat laying near a device comprising power receiving component 102, which determined proximity can be employed by WPTS component 106 in modifying the wirelessly transmitted power of wireless power/data link 108 to change, reduce, or suspend exposure of the cat to the higher energy density area proximate to power receiving component 102.

Modification, alteration, adaptation, etc., of the higher energy density area can comprise suspending the transmission or wireless power. Moreover, modification, alteration, adaptation of the higher energy density area can comprise decreasing (or increasing) the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area; moving the higher energy density area; repositioning the higher density energy area; etc. As an example, the higher energy density area can comprise a wide distribution of energy in the volume of the higher energy density area, which distribution of energy can be modified by beamforming to result in one or more narrower peak energy densities in the area, etc. As a further example, wireless power can be suspended to remove the higher energy density area. As a still further example, the energy of the higher energy density area can be uniformly (on non-uniformly) reduced to expose objects in the area to lower levels of EM energy. It is noted that nearly any change to the energy of the higher energy density area falls within the scope of the present disclosure, even where not enumerated for the sake of clarity and brevity.

In some embodiments, proximity information 112 can comprise distance or proximity information that can be employed by WPTS component 106 to determine the adaptation to the transmitted power. In some embodiments, proximity information 112 can comprise adaptation information determined by power receiving component 102 based on a proximity, distance, etc., to object 120, whereby the adaptation information of proximity information 112 can be employed by WPTS component 106 as instructions for modifying the transmitted power. In an aspect, a relative spatial relationship, e.g. proximity, etc., can be defined by multiple degrees of freedom of the relative objects, e.g. two degrees of freedom, three degrees of freedom, six degrees of freedom, etc. In some embodiments, proximity information 112 can be supplemented by other information, e.g., external data 540, when determining modifications to transmitted power by WPTS component 106.

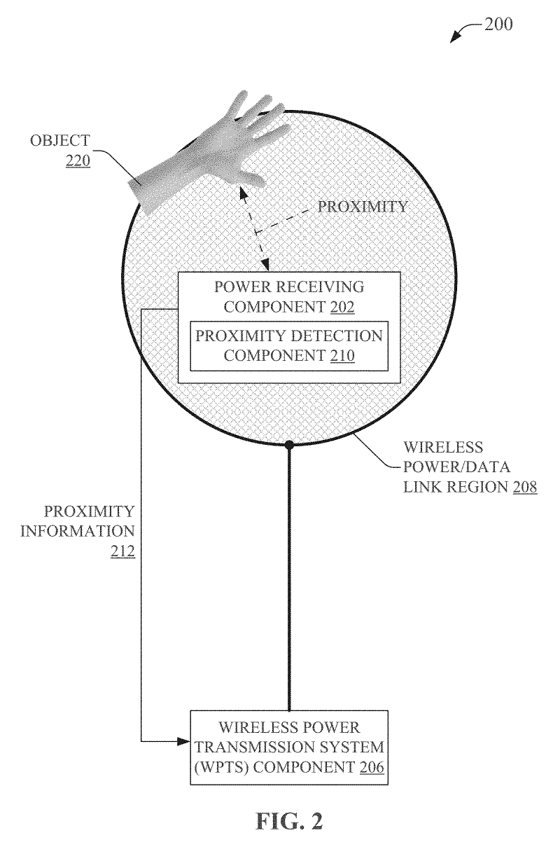

FIG. 2 is an illustration of a system 200, which can facilitate adaptation of wireless power transmission based on a proximity of living tissue to a region of higher energy density, in accordance with aspects of the subject disclosure. System 200 can comprise power receiving component 202. In an aspect, power receiving component 202, can convert EM energy into electricity that can be used, stored, etc.

System 200 can further comprise WPTS component 206. WPTS component 206 can send wireless power. In an aspect, WPTS component 206 can send wireless power via wireless power/data link 208. Wireless power/data link 208 can cause an area of higher energy density, e.g., proximate to power receiving component 202, to enable power receiving component 202 to harvest the wireless energy, and receive any data sent via wireless power/data link 208, wirelessly. In an aspect, transmitters of EM energy, e.g., wireless power transmission system (WPTS) component 206, 901A, 901B, etc., can be employed to cause a high energy density area, see FIG. 13B, etc. This high energy density area, in some embodiments, can be caused by constructive and/or destructive interference of EM waves in a region. The high energy density of an area can enable power receiving component 202 to ‘harvest’ the EM energy of the high energy density area for use as electrical energy, e.g., charging a phone, powering an internet of things (IOT) device, etc. Proximity information 212 can be communicated from power receiving component 202, e.g., via determination by proximity detection component 210. In an aspect, proximity detection component 210 can determine a proximity between an area of higher energy density, e.g., wireless power/data link region 208, etc., associated with providing wireless power to power receiving component 202, etc., and object 220, e.g., a hand, head, dog, fish, etc., to power receiving component 202.

In an embodiment, WPTS component 206 can receive proximity information 212. Proximity information 212 can indicate a proximity of an object, e.g., hand 220, etc., to the area of higher energy density, e.g., wireless power/data link region 208, etc. In an aspect, higher power density at power receiving component 202 can enable harvesting of the energy for conversion to electrical energy. However, exposure of object 220 to the higher power density caused by wireless power/data link region 208 can be undesirable. In some embodiments, it can be desirable to suspend transmission of wireless power when object 220 is within a determined proximity of wireless power/data link region 208. Moreover, even where wireless power/data link region 208 is illustrated as two-dimensional for ease of illustration, the instant disclosure includes three-dimensional wireless power/data link region 208. Still further, whole wireless power/data link region 208 is illustrated as being circular, it is noted that wireless power/data link region 208 can be of any two-dimensional or three-dimensional shape, e.g., a circle, sphere, ellipsoid, toroid, annulus, tear-drop shaped, comprising multiple tear-drop shapes, combinations thereof, etc.

Modification, alteration, adaptation, etc., of the higher energy density area can comprise suspending the transmission or wireless power. Moreover, modification, alteration, adaptation of the higher energy density area can comprise decreasing (or increasing) the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area, e.g., wireless power/data link region 208, etc., falls within the scope of the present disclosure, even where not enumerated for the sake of clarity and brevity.

In some embodiments, proximity information 212 can comprise distance or proximity information that can be employed by WPTS component 206 to determine the adaptation to the transmitted power. As an example, proximity information 212 can indicate a distance, can indicate that object 220 is within wireless power/data link region 208, can indicate that object 220 is outside of wireless power/data link region 208, can indicate that object 220 is partially within wireless power/data link region 208, etc. In some embodiments, proximity information 212 can comprise adaptation information determined by power receiving component 202 based on a proximity, distance, etc., to object 220, whereby the adaptation information of proximity information 212 can be employed by WPTS component 206 as instructions for modifying the transmitted power. In some embodiments, proximity information 212 can be supplemented by other information, e.g., external data 540, when determining modifications to transmitted power by WPTS component 206.

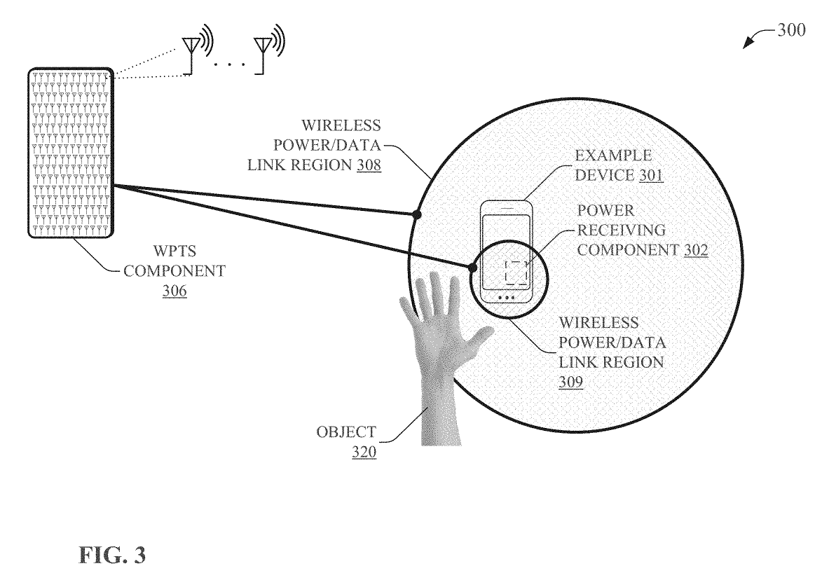

FIG. 3 is an illustration of a system 300 that can enable modification of wireless power transmission based on a spatial relationship of an object to one or more areas of higher energy density, in accordance with aspects of the subject disclosure. System 300 can comprise power receiving component 302. In an aspect, power receiving component 302, can convert EM energy into electricity that can be used, stored, etc. Power receiving component 302 can be comprised in a device such as example device 301, e.g., a smartphone, laptop computer, wireless speaker, etc.

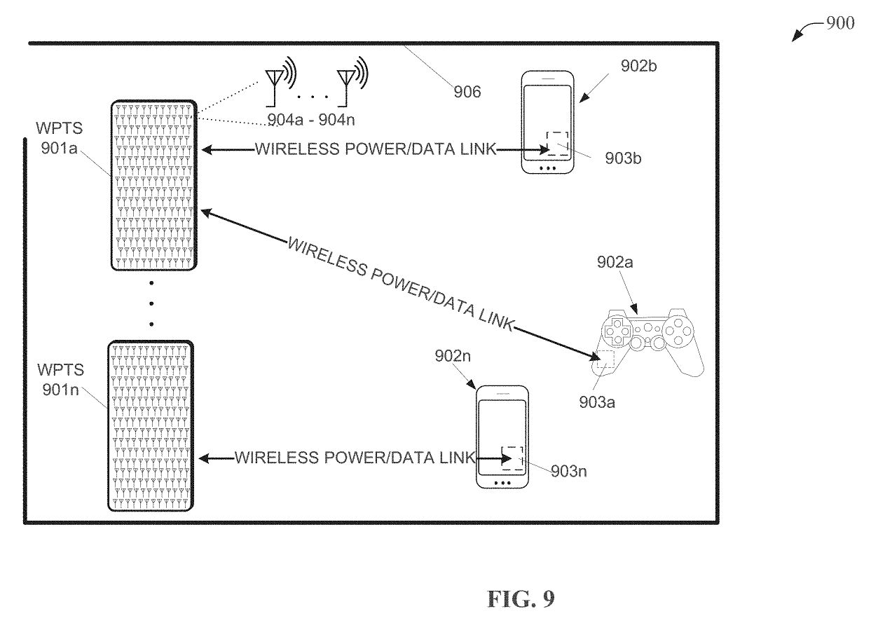

System 300 can further comprise WPTS component 306. WPTS component 306 can send wireless power. In an embodiment, WPTS component 306 can comprise an array of antennas to send RF energy in a manner that can cause a higher energy density area, e.g., wireless power/data link 308, 309, etc., see FIGS. 9-11, 13, etc. In an aspect, WPTS component 306 can send wireless power via wireless power/data link 308, 309, etc. Wireless power/data link 308, 309, etc., can form an area of higher energy density, e.g., proximate to power receiving component 302, to enable power receiving component 302 to harvest the wireless energy, and receive any data sent via wireless power/data link 308, wirelessly. This high energy density area, in some embodiments, can be caused by constructive and/or destructive interference of EM waves in a region. The high energy density of an area can enable power receiving component 302 to ‘harvest’ the EM energy of the high energy density area for use as electrical energy in example device 301, etc.

In an aspect, a high energy density area can be of different shapes and sizes as disclosed elsewhere herein. As illustrated, wireless power/data link 308 can be of larger area than wireless power/data link 309. In some embodiments this can be a result of the wireless power transmission frequency, for example, where power is transmitted at 2.4 GHz, a minimum area of the corresponding higher energy density area can be, in two-dimensional space, generally 10x larger than a minimum area of a higher energy density area corresponding to wireless power transmission at 24 GHz.

Proximity information can be communicated from power receiving component 302 to WPTS component 306 to enable adaptation of wireless power/data link 308, 309, etc. In an aspect, a proximity detection component, e.g., 110, 210, etc., can determine a proximity between an area of higher energy density, e.g., wireless power/data link region 308, 309, etc., associated with providing wireless power to power receiving component 302, etc., and object 320, e.g., a hand, head, table, television, plant, etc.

In an embodiment, WPTS component 306 can receive proximity information and can correspondingly modify wirelessly transmitted power. In an embodiment, wirelessly transmitted power can be suspended in response to determining that object 320 is, at least in part, within a determined proximity of wireless power/data link 308, 309, etc., e.g., based on a proximity to power receiving component 302 and information pertaining to the area/shape of wireless power/data link 308, 309, etc., e.g. a region corresponding to the wireless power/data link 308, 309, etc., for example, a region as illustrated in FIG. 3, etc. Conversely, where object 320 is determined to not be at least partially within wireless power/data link 308, 309, etc., wirelessly transmitted power can be resumed. Moreover, exposure of object 320 to the higher power density caused by wireless power/data link 308, 309, etc., can be undesirable. As such, in response to determining the proximity of object 320 relative to wireless power/data link 308, 309, etc., such determining a distance from example device 301, power receiving component 302, etc., in conjunction with information related to the characteristics of wireless power/data link 308, 309, etc., transmitted power can be adapted to reduce, increase, or change a shape or density of energy within wireless power/data link 308, 309, etc. This can serve to provide more safe operation of a wireless power transmission technology, e.g., in regard to meeting standards or best practices in exposure of object 320 to the higher energy density area.

Further, determining the proximity of object 320 relative to wireless power/data link 308, 309, etc., can be augmented by determining a characteristic of object 320. In an aspect, exposure to EM energy of the higher energy density areas can affect different object differently. As an example, where a phone sits on a wooden desk, modification of the power delivered to the higher energy density area can be different that if the example phone is resting on a person's chest while they lounge on a couch watching a movie. This difference can be based on a characteristic of the object, e.g., the example wooden desk in comparison to the example human chest, where the orientation of the example phone and the proximity to the ‘object’ is the same in both example cases. As will be appreciated, exposing living tissue to high density EM energy can be more closely scrutinized than the wooden desk. Accordingly, the adaptation of the higher energy density area for the human chest can be different from the wooden desk. The characteristic of object 320 can be determined in nearly any manner, as examples, detecting a heartbeat, breathing sounds, warmth, etc., can indicate living tissue, and, for example, where the warmth is at or near 98.6 degrees Fahrenheit, can be determined to be human living tissue where other animals can be associated with other temperatures. As further examples, changes in dielectric fields can be used to determine a characteristic of object 320, an accelerometer can indicate movement of example device 301 that can be correlated to human movement, vehicular movement, etc., sonar can be used to map an object or movement of an object, a pressure sensor can detect the pressure waves of a cat purring, etc. While all of the many sensors and types of sensors to detect characteristics of object 320 are not explicitly illustrated, all such sensors are within the scope of the instant disclosure. Moreover, we note that information from one, some, or all sensors, and/or external data such as external data 540, can be used, combined, etc., to facilitate determining one or more characteristic of object 320 to facilitate adapting the higher energy density area in an appropriate manner.

Modification, alteration, adaptation, etc., of the higher energy density area can comprise suspending the transmission of wireless power. Moreover, modification, alteration, adaptation of the higher energy density area can comprise decreasing (or increasing) the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area, e.g., wireless power/data link 308, 309, etc., falls within the scope of the present disclosure, even where not enumerated for the sake of clarity and brevity.

In some embodiments, proximity information can comprise distance or proximity information that can be employed by WPTS component 306 to determine the adaptation to the transmitted power. As an example, proximity information can indicate a distance measurement, can indicate that object 320 is within wireless power/data link 308, 309, etc., can indicate that object 320 is outside of wireless power/data link 308, 309, etc., can indicate that object 320 is partially within wireless power/data link 308, 309, etc. In some embodiments, proximity information can comprise adaptation information determined by power receiving component 302 based on a proximity, distance, etc., to object 320, whereby the adaptation information of proximity information can be employed by WPTS component 306 to facilitate modifying the transmitted power. In some embodiments, proximity information can be supplemented by other information, e.g., external data 540, when determining modifications to transmitted power by WPTS component 306.

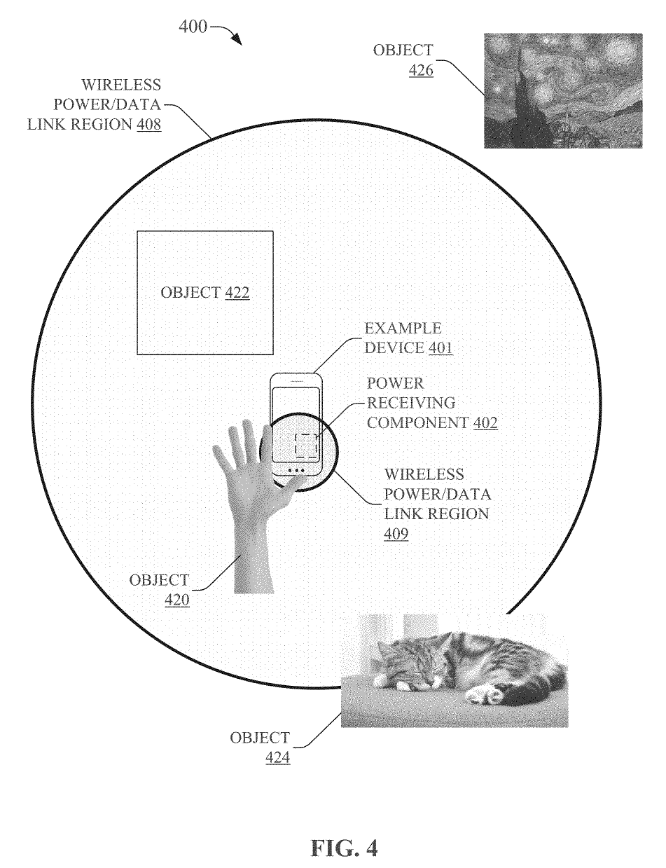

FIG. 4 an illustration of a system 400 that can enable altering wireless power transmission based on distances of objects to one or more areas of higher energy density, in accordance with aspects of the subject disclosure. System 400 can comprise power receiving component 402. In an aspect, power receiving component 402, can convert EM energy into electricity that can be used, stored, etc. Power receiving component 402 can be comprised in a device such as example device 401, e.g., a smartphone, laptop computer, wireless speaker, etc.

System 400 can receive wireless power from a WPTS component, e.g., WPTS component 106, 206, 306, etc. Wireless power can form an area of higher energy density, e.g., proximate to power receiving component 402, to enable power receiving component 402 to harvest the wireless energy. This high energy density area, in some embodiments, can be caused by constructive and/or destructive interference of EM waves in a region. The high energy density of an area can enable power receiving component 402 to ‘harvest’ the EM energy of the high energy density area for use as electrical energy in example device 401, etc.

In an aspect, a high energy density area can be of different shapes and sizes. As illustrated, wireless power/data link 408 can be of larger area than wireless power/data link 409. In some embodiments this can be a result of the wireless power transmission frequency, for example, where power is transmitted at 800 MHz, a minimum area of the corresponding higher energy density area can be, in two dimensional space, generally 10× larger than a minimum area of a higher energy density area corresponding to wireless power transmission at 8 GHz, volume of corresponding three-dimensional space for the area can also scale as a function of the wireless power transmission frequency.

Proximity information can be communicated from power receiving component 402 to the WPTS component to enable adaptation of wireless power/data link 408, 409, etc. In an aspect, a proximity detection component, e.g., 110, 210, etc., can determine a proximity between an area of higher energy density, e.g., wireless power/data link region 408, 409, etc., associated with providing wireless power to power receiving component 402, etc., and objects 420-426. In an embodiment, a WPTS component can the receive proximity information and can correspondingly modify wirelessly transmitted power. In an embodiment, wirelessly transmitted power can be suspended in response to determining that object is, at least in part, within a determined proximity of wireless power/data link 408, 409, etc., e.g., based on a proximity to power receiving component 402 and information pertaining to the area/shape of wireless power/data link 408, 409, etc. Conversely, where object is determined to not be at least partially within wireless power/data link 408, 409, etc., e.g., object 426 is completely outside of both wireless power/data link 408 and 409, and objects 422, 424, and 426 are completely outside of wireless power/data link 409, wirelessly transmitted power can be resumed in the corresponding areas. Moreover, exposure of objects to the higher power density caused by wireless power/data link 408, 409, etc., can be undesirable. As such, in response to determining the proximity of objects relative to wireless power/data link 408, 409, etc., such as determining a distance from example device 401, power receiving component 402, etc., in conjunction with information related to the characteristics of wireless power/data link 408, 409, etc., transmitted power can be adapted to reduce, increase, or change a shape or density of energy within wireless power/data link 408, 409, etc. This can serve to provide safer operation of a wireless power transmission technology, e.g., in regard to meeting standards or best practices in exposure of objects 420-426, etc., to the higher energy density area.

Further, determining the proximity of objects relative to wireless power/data link 408, 409, etc., can be augmented by determining a characteristic of the objects. In an aspect, exposure to EM energy of the higher energy density areas can affect different objects differently. As an example, where example device 401 is being held by a hand, e.g., object 420, modification of the power delivered to the higher energy density areas, e.g., wireless power/data link 408, 409, etc., can be different than an adjustment made where a pet is proximate, e.g., object 424, e.g., the power of wireless power/data link 408 and 409 can be suspended for the example hand, while wireless power/data link 409 can be unmodified and wireless power/data link 408 can be reduced for the example pet. This difference can be based on the proximity, a characteristic of the object, combinations thereof, etc. As a further example, if example device 401 is determined to be held by a hand, e.g., object 420, modification of the power delivered to the higher energy density areas, e.g., wireless power/data link 408, 409, etc., can be different than an adjustment made where an object is not proximate, e.g., object 426 is outside of the both wireless power/data link 408 and 409. Moreover, where object 422 can be, for example, a desk, wireless power/data link 409 can be unmodified and wireless power/data link 408 can be altered in a manner that is different than might be used for living tissue because the desk, e.g., object 422, has different characteristics with regard to affects from higher energy density areas. As will be appreciated, exposing living tissue to high density EM energy can be more closely scrutinized than the wooden desk. Accordingly, the adaptation of the higher energy density area for the human hand can be different from the wooden desk. The characteristics of objects can be determined in nearly any manner and nearly any sensor can be employed to detect characteristics of objects 420-426, even where they are not explicitly recited for clarity and brevity. Moreover, we note that information from one, some, or all sensors, and/or external data such as external data 540, can be used, combined, etc., to facilitate determining one or more characteristic of one or more of objects 420-426 to facilitate adapting the higher energy density area in an appropriate manner.

Modification, alteration, adaptation, etc., of the higher energy density area can comprise suspending the transmission or wireless power. Moreover, modification, alteration, adaptation of the higher energy density area can comprise decreasing/increasing the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area, e.g., wireless power/data link 408, 409, etc., falls within the scope of the present disclosure, even where not enumerated for the sake of clarity and brevity.

In some embodiments, proximity information can comprise distance or proximity information that can be employed by a WPTS component to determine the adaptation to the transmitted power. As an example, proximity information can indicate a distance measurement, can indicate that one or more of objects 420-426 is within one or more of wireless power/data link 408, 409, etc., can indicate that one or more of objects 420-426 is outside of one or more of wireless power/data link 408, 409, etc., can indicate that one or more of objects 420-426 is partially within one or more of wireless power/data link 408, 409, etc. In some embodiments, proximity information can comprise adaptation information determined by power receiving component 402 based on a proximity, distance, etc., to one or more of objects 420-426, whereby the adaptation information of proximity information can be employed by a WPTS component to facilitate modifying the transmitted power. In some embodiments, proximity information can be supplemented by other information, e.g., external data 540, when determining modifications to transmitted power by a WPTS component.

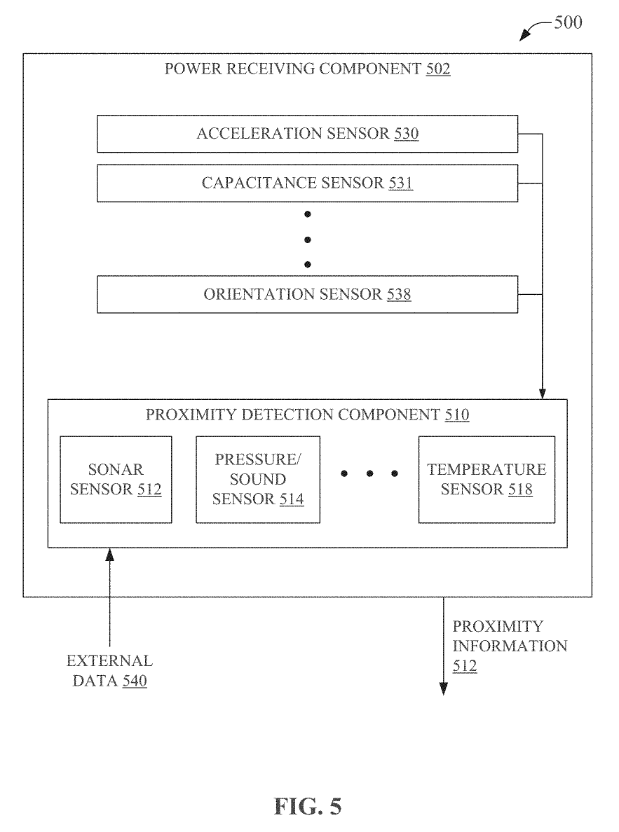

FIG. 5 is an illustration of a system 500 that can enable adaptation of wireless power transmission based on a proximity of an object to an area of higher energy density and based on a characteristic of the object, in accordance with aspects of the subject disclosure. System 500 can comprise power receiving component 502. In an aspect, power receiving component 502, can convert EM energy into electricity that can be used, stored, etc. Power receiving component 502 can be comprised in a device such as a smartphone, laptop computer, security camera, etc.

Proximity information can be communicated from power receiving component 502 to a WPTS component to enable adaptation of an area of higher energy density formed by wireless transmissions from the WPTS component. In an aspect, a proximity detection component 510 can determine a proximity between an area of higher energy density associated with providing wireless power to power receiving component 502, etc., and an object, e.g., a hand, head, table, television, plant, etc. The proximity information can be employed to adapt wirelessly transmitted power. This can serve to provide improve operation of a wireless power transmission technology, e.g., in regard to meeting standards or best practices in regard to exposure of the object to the higher energy density area.

Further, determining the proximity of an object relative to an area of higher energy density from a WPTS can be augmented by determining a characteristic of the object, e.g., as proximity information 512. In an aspect, exposure to EM energy of the higher energy density areas can affect different objects differently. A characteristic of an object can be determined in nearly any manner, as examples, detecting a heartbeat, breathing sounds, warmth, changes in dielectric fields, movement, etc. In an aspect, power receiving component 502 can comprise one or more sensor. Similarly, proximity detection component 510 can comprise one or more sensor. Moreover, a device comprising power receiving component 502 can comprise one or more sensor. Further, other external sensors can be employed to provide data, e.g., external data 540, to aid in determining a proximity of, or a characteristic of, an object to a higher energy density area. In an aspect, proximity information 512 can comprise proximity information, object characteristic information, combinations thereof, etc.

In an aspect, power receiving component 502 can comprise an acceleration sensor 530, e.g., an accelerometer. An acceleration sensor 530 can enable detection of movement, or patterns of movement, corresponding to power receiving component 502, or a device comprising power receiving component 502. Power receiving component 502 can further comprise capacitance sensor 531 that can detect change in an electromagnetic field, a change in a dielectric field, etc., as an example, a capacitive sensor can determine that a finger is proximate to a touch screen display, etc. Power receiving component 502 can additionally comprise orientation sensor 538 that can determine an orientation, or changing in an orientation, of power receiving component 502 or a device comprising power receiving component 502, as an example, if a smartphone is rotated, it can be inferred that a person can have rotated the smartphone and that the person would be proximate to the smartphone.

In another aspect, proximity detection component 510 can comprise sonar sensor 512 that can map an area based on sonar signals. Additionally, proximity detection component 510 can comprise pressure/sound sensor 514 that can capture pressure information, e.g., heartbeat, breathing sound, purring, etc. Proximity detection component 510 can additionally comprise temperature sensor 518 that can capture thermal data, such as body temperature, ambient temperature, etc.

In an aspect, power receiving component 502 and/or proximity detection component 510 can comprise additional sensors or sensor types other than those illustrated, and all such other sensors or types of sensors are to be considered within the scope of the present invention despite not being explicitly recited for the sake of clarity and brevity. Further, the sensors illustrated for power receiving component 502 can equally be embodied in proximity detection component 510, sensors illustrated for proximity detection component 510 can equally be embodied in power receiving component 502, and one, some, or all sensors illustrated can be embodied in other components that are not illustrated for the sake of brevity and clarity. Moreover, information from one, some, or all sensors, and/or external data such as external data 540, can be used, combined, etc., to facilitate determining a proximity of an object, to facilitate determining one or more characteristic of an object, etc., to facilitate adapting a higher energy density area as is disclosed elsewhere herein.

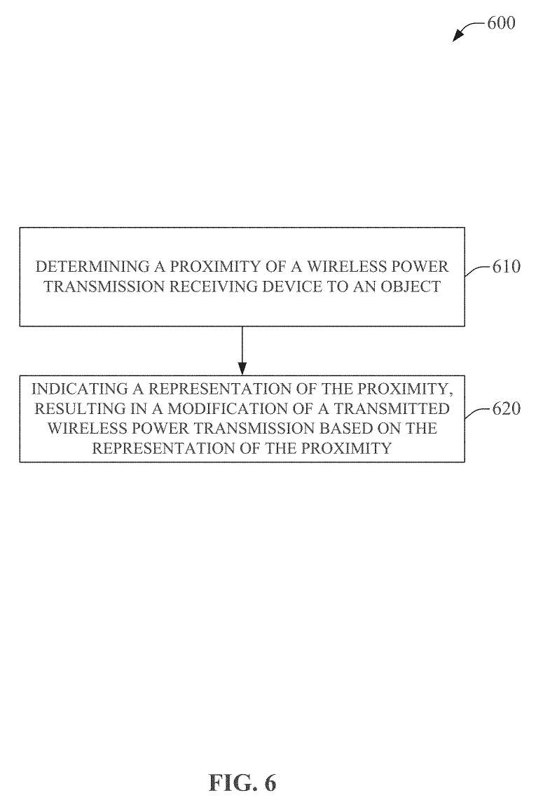

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, which can enable adaptation of wireless power transmission based on a proximity of an object to an area of higher energy density, in accordance with aspects of the subject disclosure. At 610, method 600 can enable determining a proximity of a wireless power transmission receiving device to an object. Wireless power transmission receiving device, e.g., power receiving component 102, 202, 302, 402, 502, etc., can be, in some embodiments, comprised in a device such as a cellphone, laptop computer, game controller, television, clock, microwave, stereo equipment, vehicle, or nearly any other device that uses electrical power. In an aspect, wireless power transmission receiving device, can convert electromagnetic (EM) energy into electricity that can be used, stored, etc. The electromagnetic energy can be radio frequency (RF) energy, for example, can be millimeter wave energy, microwave energy, 2.4 GHz energy, 800 MHz energy, 24 GHz energy, or nearly any other energy of the electromagnetic spectrum. In an aspect, transmitters of EM energy, e.g., wireless power transmission system (WPTS) component 106, 901A, 901B, etc., can be employed to cause a high energy density area, see FIG. 13B, etc. This high energy density area, in some embodiments, can be caused by constructive and/or destructive interference of EM waves in a region. The high energy density of an area can enable wireless power transmission receiving device to ‘harvest’ the EM energy of the high energy density area for use as electrical energy, e.g., charging a phone, powering an internet of things (IOT) device, etc.

Proximity information can be represented in the representation of the proximity and can indicate a proximity of an object, e.g., object 120, 220, 320, 420-426, etc., to an area of higher energy density. Exposure of an object, while facilitating harvesting of energy for electrical power, can also be undesirable in other aspects, e.g., can generate heat, may lead to medical issues, can affect a normal function of an object, etc. For example, where a cellphone is held to a user's ear, it can be undesirable to create a higher energy density area at the user's head. EM field exposure to human body parts is typically regulated with limits set for safe use. As such, where an object such as a human head is close to a higher energy density area, it can be desirable to change or suspend the higher energy density area, e.g., to meet governmental or other standards, best practices, etc. In some embodiments, it can be desirable to suspend transmission of wireless power. Similarly, proximity to other objects can be employed to modify the wirelessly transmitted power into the higher energy density area, e.g., to reduce interference with sensitive electronics, to protect artwork or furniture, etc.

Modification, alteration, adaptation, etc., of the higher energy density area can comprise suspending/activating the transmission or wireless power. Moreover, modification, alteration, adaptation of the higher energy density area can comprise decreasing/increasing the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area falls within the scope of the present disclosure, even where not enumerated for the sake of clarity and brevity.

Method 600, at 620, can facilitate indicating a representation of the proximity. The representation of the proximity can be employed to modify a transmitted wireless power transmission. At this point, method 600 can end. In an aspect, the representation can be provided to a device that transmits wireless power to enable the device to adapt the transmitted power based on the representation of the proximity.

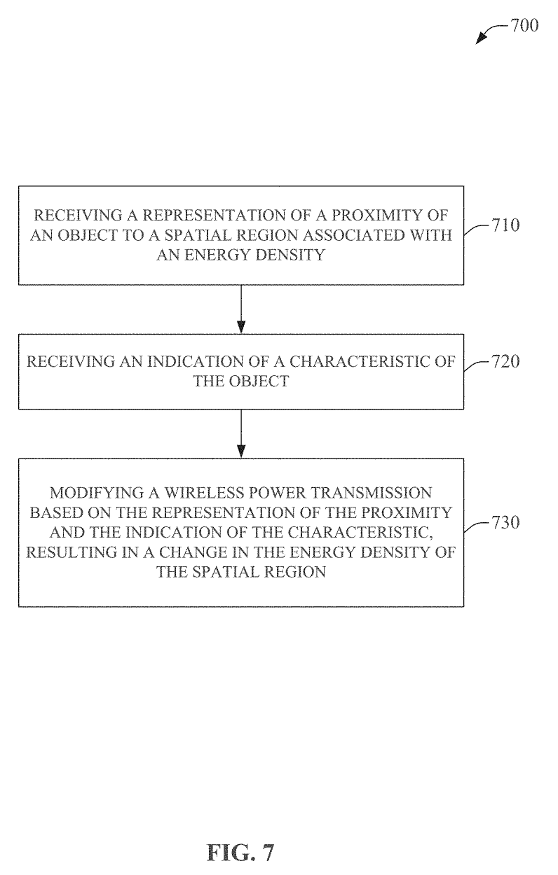

FIG. 7 illustrates example method 700 that facilitates adaptation of wireless power transmission based on a characteristic of an object and based on a proximity of an object to an area of higher energy density, in accordance with aspects of the subject disclosure. Method 700, at 710, can comprise receiving a representation of a proximity of an object to an area associated with a radio frequency density. In an aspect, the area can be a higher energy density area associated with wireless power transmission. The representation of the proximity can indicate a proximity of an object, e.g., object 120, 220, 320, 420-426, etc., to an area of higher energy density. Exposure of an object, can be desirable, e.g., facilitating harvesting of energy for electrical power, and can be undesirable in other aspects, e.g., can generate heat, may lead to medical issues, can affect a normal function of an object, etc. As such, where an object is close to a higher energy density area, it can be desirable to change or suspend the higher energy density area, e.g., to meet governmental or other standards, best practices, etc. In some embodiments, it can be desirable to suspend transmission of wireless power. Similarly, proximity to other objects can be employed to modify the wirelessly transmitted power into the higher energy density area, e.g., to reduce interference with sensitive electronics, to protect artwork or furniture, etc.

At 720, method 700 can comprise receiving an indication of a characteristic of the object. A characteristic of the object can facilitate differentiation between different types of object based on more than just their relative proximities. In an aspect, exposure to EM energy of the higher energy density areas can affect different object differently. This difference can be based on a characteristic of the object, e.g., for an example wooden desk in comparison to an example human chest, the two objects can react differently to a same higher energy density area. As will be appreciated, exposing living tissue to high density EM energy can be more concerning that exposing the wooden desk to the same energy density. Accordingly, the adaptation of the higher energy density area for the human chest can be different from the wooden desk. The indication of a characteristic of an object can be determined in nearly any manner, as disclosed elsewhere herein. While all of the many sensors and types of sensors to detect characteristics of an object are not explicitly recited, all such sensors are within the scope of the instant disclosure. Moreover, we note that information from one, some, or all sensors, and/or external data such as external data 540, can be used, combined, etc., to facilitate determining one or more indication of a characteristic of an object to facilitate adapting the higher energy density area in an appropriate manner.

At 730, a wireless power transmission can be modified based on the representation of the proximity and the representation of the characteristic of the object. This can result in a change in the radio frequency density in the area. At this point method 700 can end. Modification, alteration, adaptation, etc., of the higher energy density area can comprise suspending/activating the transmission or wireless power. Moreover, modification, alteration, adaptation of the higher energy density area can comprise decreasing/increasing the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area falls within the scope of the present disclosure, even where not enumerated for the sake of clarity and brevity.

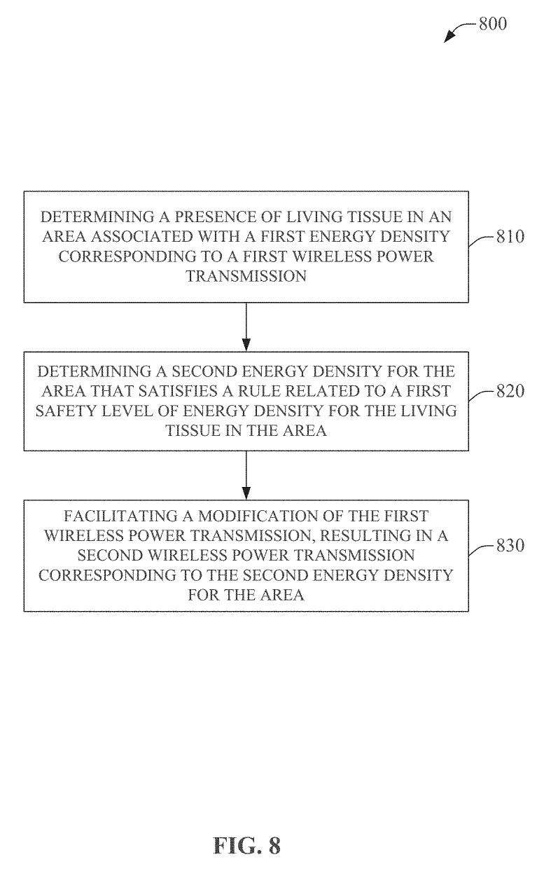

FIG. 8 illustrates example method 800, which can enable adaptation of wireless power transmission based on a rule related to a safety level for living tissue having a proximity to an area of higher energy density, in accordance with aspects of the subject disclosure. At 810, method 800 can enable determining a presence of living tissue in an area associated with a first radio frequency density corresponding to a first wireless power transmission. The presence can be correlated to a proximity of a wireless power transmission receiving device to the living tissue. Wireless power transmission receiving device, e.g., power receiving component 102, 202, 302, 402, 502, etc., can be, in some embodiments, comprised in a device such as a cellphone, laptop computer, game controller, television, clock, microwave, stereo equipment, vehicle, or nearly any other device that uses electrical power. In an aspect, wireless power transmission receiving device, can convert electromagnetic (EM) energy into electricity that can be used, stored, etc. In an aspect, transmitters of EM energy, e.g., WPTS component 106, 901A, 901B, etc., can be employed to cause a high energy density area, see FIG. 13B, etc. This high energy density area, in some embodiments, can be caused by constructive and/or destructive interference of EM waves in a region. The high energy density of an area can enable wireless power transmission receiving device to ‘harvest’ the EM energy of the high energy density area for use as electrical energy, e.g., charging a phone, powering an internet of things (IOT) device, etc.

The presence of the living tissue, e.g., as proximate to the wireless power transmission receiving device, etc., can relate to an adaptation of the first radio frequency density. Exposure of an object can be both desirable for some aspects and undesirable in other aspects. As such, at 820 of method 800, a second radio frequency density for the area can be determined. The second radio frequency density can be determined to satisfy a rule related to a first safety level of radio frequency density for the living tissue in the area. In some embodiments, it can be desirable to suspend transmission of wireless power. In other embodiments, it can be desirable to adapt the transmitted power to a ‘safe level’ for living tissue, e.g., as prescribed by regulation, best practices, etc.

Modification, alteration, adaptation, etc., of the higher energy density area can comprise suspending/activating the transmission or wireless power. Moreover, modification, alteration, adaptation of the higher energy density area can comprise decreasing/increasing the transmission or wireless power to the higher energy density area. Further, modification, alteration, adaptation of the higher energy density area can comprise altering the size or shape of the higher energy density area, e.g., increasing or decreasing the area, volume, etc. Still further, modification, alteration, adaptation of the higher energy density area can comprise altering the distribution of energy in the higher energy density area, e.g., focusing, defocusing, creating nulls, etc., of the energy within the higher energy density area. It is noted that nearly any change to the energy of the higher energy density area falls within the scope of the present disclosure, even where not enumerated for the sake of clarity and brevity.

Method 800, at 830, can facilitate a modification of the first wireless power transmission to result in a second wireless power transmission corresponding top the second radio frequency density for the area. At this point, method 800 can end. In an embodiment, the determined second radio frequency density can be communicated to a WPTS component to facilitate adaptation of the transmitted power in accord with the determined second radio frequency density.

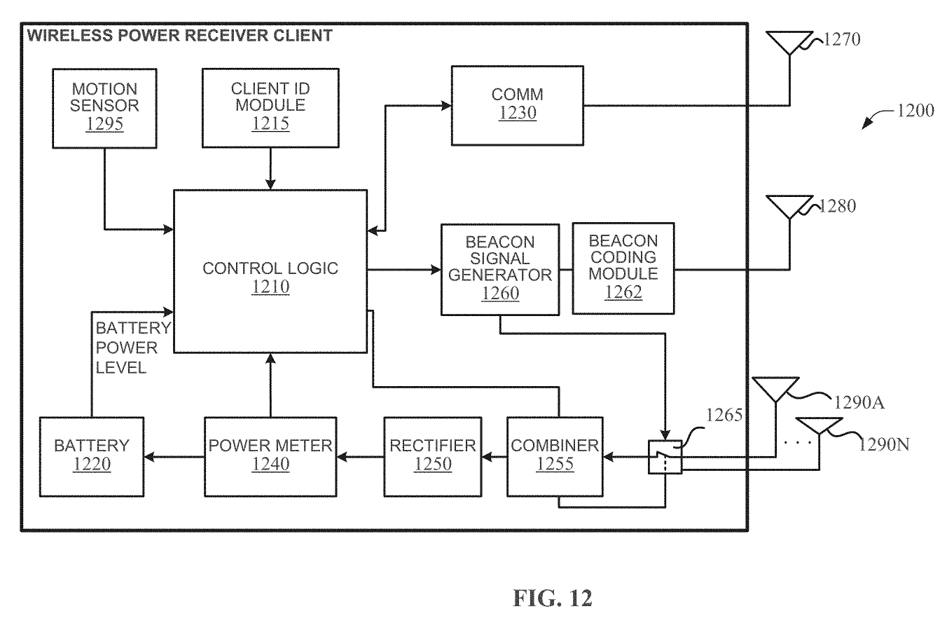

FIG. 9 depicts a block diagram including an example wireless power delivery environment 900 illustrating wireless power delivery from one or more wireless power transmission systems (WPTS) 901a-n (also referred to as “wireless power delivery systems”, “antenna array systems” and “wireless chargers”) to various wireless devices 902a-n within the wireless power delivery environment 900, according to some embodiments. More specifically, FIG. 9 illustrates an example wireless power delivery environment 900 in which wireless power and/or data can be delivered to available wireless devices 902a-902n having one or more wireless power receiver clients 903a-903n (also referred to herein as “clients” and “wireless power receivers”). The wireless power receiver clients are configured to receive and process wireless power from one or more wireless power transmission systems 901a-901n. Components of an example wireless power receiver client 903 are shown and discussed in greater detail with reference to FIG. 12.

As shown in the example of FIG. 9, the wireless devices 902a-902n include mobile phone devices and a wireless game controller. However, the wireless devices 902a-902n can be any device or system that needs power and is capable of receiving wireless power via one or more integrated wireless power receiver clients 903a-903n. As discussed herein, the one or more integrated wireless power receiver clients receive and process power from one or more wireless power transmission systems 901a-901n and provide the power to the wireless devices 902a-902n (or internal batteries of the wireless devices) for operation thereof.

Each wireless power transmission system 901 can include multiple antennas 904a-n, e.g., an antenna array including hundreds or thousands of antennas, which are capable of delivering wireless power to wireless devices 902a-902n. In some embodiments, the antennas are adaptively-phased RF antennas. The wireless power transmission system 901 is capable of determining the appropriate phases with which to deliver a coherent power transmission signal to the wireless power receiver clients 903a-903n. The array is configured to emit a signal (e.g., continuous wave or pulsed power transmission signal) from multiple antennas at a specific phase relative to each other. It is appreciated that use of the term “array” does not necessarily limit the antenna array to any specific array structure. That is, the antenna array does not need to be structured in a specific “array” form or geometry. Furthermore, as used herein the term “array” or “array system” may include related and peripheral circuitry for signal generation, reception and transmission, such as radios, digital logic and modems. In some embodiments, the wireless power transmission system 901 can have an embedded WiFi hub for data communications via one or more antennas or transceivers.

The wireless devices 902 can include one or more wireless power receiver clients 903. As illustrated in the example of FIG. 9, power delivery antennas 904a-904n are shown. The power delivery antennas 904a are configured to provide delivery of wireless radio frequency power in the wireless power delivery environment. In some embodiments, one or more of the power delivery antennas 904a-904n can alternatively or additionally be configured for data communications in addition to or in lieu of wireless power delivery. The one or more data communication antennas are configured to send data communications to and receive data communications from the wireless power receiver clients 903a-903n and/or the wireless devices 902a-902n. In some embodiments, the data communication antennas can communicate via Bluetooth™, WiFi™, ZigBee™, etc. Other data communication protocols are also possible.

Each wireless power receiver client 903a-903n includes one or more antennas (not shown) for receiving signals from the wireless power transmission systems 901a-901n. Likewise, each wireless power transmission system 901a-901n includes an antenna array having one or more antennas and/or sets of antennas capable of emitting continuous wave or discrete (pulse) signals at specific phases relative to each other. As discussed above, each of the wireless power transmission systems 901a-901n is capable of determining the appropriate phases for delivering the coherent signals to the wireless power receiver clients 902a-902n. For example, in some embodiments, coherent signals can be determined by computing the complex conjugate of a received beacon (or calibration) signal at each antenna of the array such that the coherent signal is phased for delivering power to the particular wireless power receiver client that transmitted the beacon (or calibration) signal.

Although not illustrated, each component of the environment, e.g., wireless device, wireless power transmission system, etc., can include control and synchronization mechanisms, e.g., a data communication synchronization module. The wireless power transmission systems 901a-901n can be connected to a power source such as, for example, a power outlet or source connecting the wireless power transmission systems to a standard or primary AC power supply in a building. Alternatively, or additionally, one or more of the wireless power transmission systems 901a-901n can be powered by a battery or via other mechanisms, e.g., solar cells, etc.

The wireless power receiver clients 902a-902n and/or the wireless power transmission systems 901a-901n are configured to operate in a multipath wireless power delivery environment. That is, the wireless power receiver clients 902a-902n and the wireless power transmission systems 901a-901n are configured to utilize reflective objects 906 such as, for example, walls or other RF reflective obstructions within range to transmit beacon (or calibration) signals and/or receive wireless power and/or data within the wireless power delivery environment. The reflective objects 906 can be utilized for multi-directional signal communication regardless of whether a blocking object is in the line of sight between the wireless power transmission system and the wireless power receiver clients 903a-903n.

As described herein, each wireless device 902a-902n can be any system and/or device, and/or any combination of devices/systems that can establish a connection with another device, a server and/or other systems within the example environment 900. In some embodiments, the wireless devices 902a-902n include displays or other output functionalities to present data to a user and/or input functionalities to receive data from the user. By way of example, a wireless device 902 can be, but is not limited to, a video game controller, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. By way of example and not limitation, the wireless device 902 can also be any wearable device such as watches, necklaces, rings or even devices embedded on or within the customer. Other examples of a wireless device 902 include, but are not limited to, safety sensors (e.g., fire or carbon monoxide), electric toothbrushes, electronic door lock/handles, electric light switch controller, electric shavers, etc.

Although not illustrated in the example of FIG. 9, the wireless power transmission system 901 and the wireless power receiver clients 903a-903n can each include a data communication module for communication via a data channel. Alternatively, or additionally, the wireless power receiver clients 903a-903n can direct the wireless devices 902a-902n to communicate with the wireless power transmission system via existing data communications modules. In some embodiments, the beacon signal, which is primarily referred to herein as a continuous waveform, can alternatively or additionally take the form of a modulated signal.

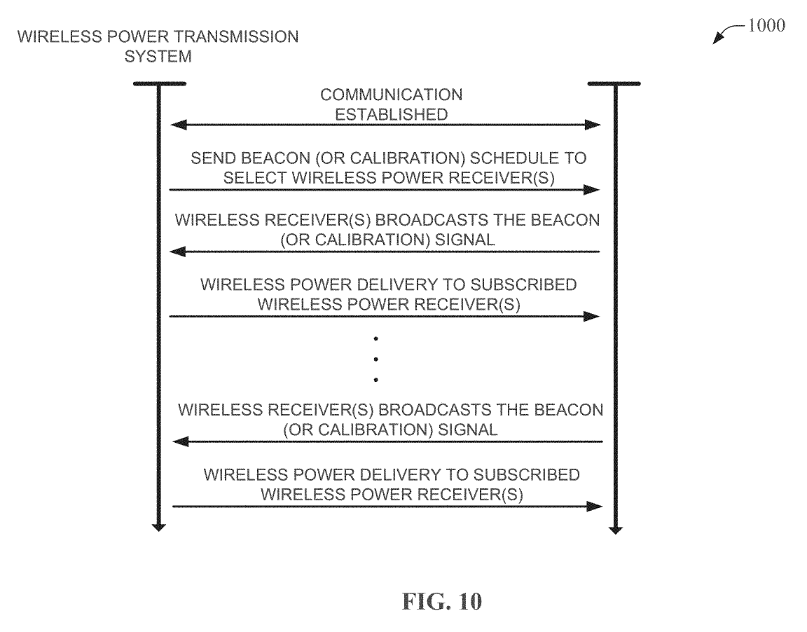

FIG. 10 depicts a sequence diagram 1000 illustrating example operations between a wireless power delivery system, e.g., WPTS component 106, etc., and a wireless power receiver client 903, e.g., power receiving component 102, etc., for establishing wireless power delivery in a multipath wireless power delivery, according to an embodiment. Initially, communication is established between the wireless power delivery system and the power receiver client. The initial communication can be, for example, a data communication link that is established via one or more antennas (e.g., 904a-904n) of the wireless power transmission system. As discussed, in some embodiments, one or more of the antennas can be data antennas, wireless power transmission antennas, or dual-purpose data/power antennas. Various information can be exchanged between the wireless power transmission system and the wireless power receiver client over this data communication channel. For example, wireless power signaling can be time sliced among various clients in a wireless power delivery environment. In such cases, the wireless power transmission system can send beacon schedule information, e.g., Beacon Beat Schedule (BBS) cycle, power cycle information, etc., so that the wireless power receiver client knows when to transmit (broadcast) its beacon signals and when to listen for power, etc.

Continuing with the example of FIG. 10, the wireless power transmission system selects one or more wireless power receiver clients for receiving power and sends the beacon schedule information to the selected wireless power receiver clients. The wireless power transmission system can also send power transmission scheduling information so that the wireless power receiver client knows when to expect (e.g., a window of time) wireless power from the wireless power transmission system. The wireless power receiver client then generates a beacon (or calibration) signal and broadcasts the beacon during an assigned beacon transmission window (or time slice) indicated by the beacon schedule information, e.g., BBS cycle. As discussed herein, the wireless power receiver client includes one or more antennas (or transceivers) that have a radiation and reception pattern in three-dimensional space proximate to the wireless device in which the wireless power receiver client is embedded.

The wireless power transmission system receives the beacon from the power receiver client and detects and/or otherwise measures the phase (or direction) from which the beacon signal is received at multiple antennas. The wireless power transmission system then delivers wireless power to the power receiver client from the multiple antennas based on the detected or measured phase (or direction) of the received beacon at each of the corresponding antennas. In some embodiments, the wireless power transmission system determines the complex conjugate of the measured phase of the beacon and uses the complex conjugate to determine a transmit phase that configures the antennas for delivering and/or otherwise directing wireless power to the wireless power receiver client via the same path over which the beacon signal was received from the wireless power receiver client.

In some embodiments, the wireless power transmission system includes many antennas. One or more of the many antennas may be used to deliver power to the power receiver client. The wireless power transmission system can detect and/or otherwise determine or measure phases at which the beacon signals are received at each antenna. The large number of antennas may result in different phases of the beacon signal being received at each antenna of the wireless power transmission system. As discussed above, the wireless power transmission system can determine the complex conjugate of the beacon signals received at each antenna. Using the complex conjugates, one or more antennas may emit a signal that takes into account the effects of the large number of antennas in the wireless power transmission system. In other words, the wireless power transmission system can emit a wireless power transmission signal from one or more antennas in such a way as to create an aggregate signal from the one or more of the antennas that approximately recreates the waveform of the beacon in the opposite direction. Said another way, the wireless power transmission system can deliver wireless RF power to the wireless power receiver clients via the same paths over which the beacon signal is received at the wireless power transmission system. These paths can utilize reflective objects 906 within the environment. Additionally, the wireless power transmission signals can be simultaneously transmitted from the wireless power transmission system such that the wireless power transmission signals collectively match the antenna radiation and reception pattern of the client device in a three-dimensional (3D) space proximate to the client device.

As shown, the beacon (or calibration) signals can be periodically transmitted by wireless power receiver clients within the power delivery environment according to, for example, the BBS, so that the wireless power transmission system can maintain knowledge and/or otherwise track the location of the power receiver clients in the wireless power delivery environment. The process of receiving beacon signals from a wireless power receiver client at the wireless power transmission system and, in turn, responding with wireless power directed to that particular wireless power receiver client is referred to herein as retrodirective wireless power delivery.

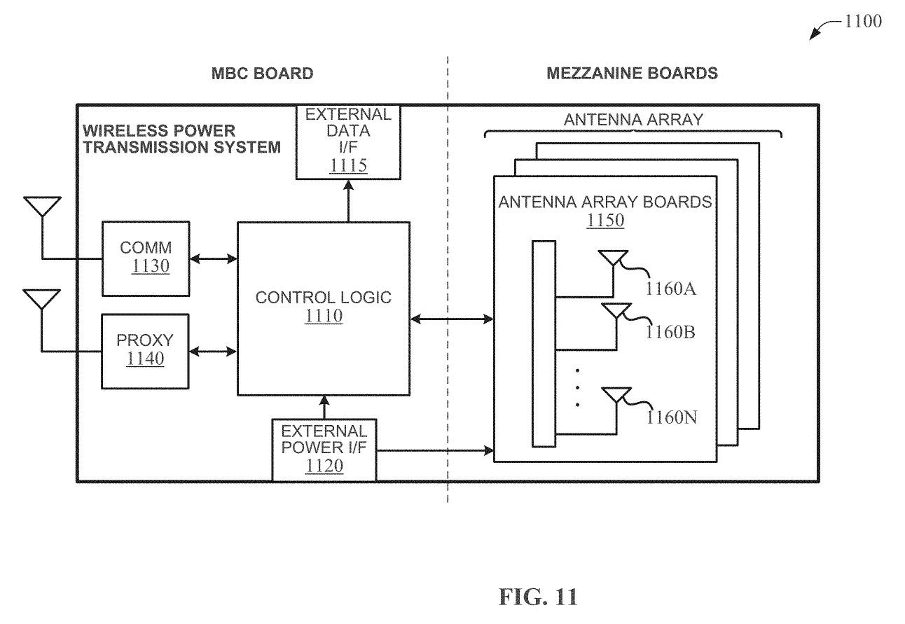

Furthermore, as discussed herein, wireless power can be delivered in power cycles defined by power schedule information. A more detailed example of the signaling required to commence wireless power delivery is described now with reference to FIG. 11.

FIG. 11 depicts a block diagram illustrating example components of a wireless power transmission system 1100, in accordance with an embodiment. As illustrated in the example of FIG. 11, the wireless power transmission system 1100 includes a master bus controller (MBC) board and multiple mezzanine boards that collectively comprise the antenna array.

The MBC includes control logic 1110, an external data interface (I/F) 1115, an external power interface (I/F) 1120, a communication block 1130 and proxy 1140. The mezzanine boards (or antenna array boards 1150) each include multiple antennas 1160a-1160n. Some or all of the components can be omitted in some embodiments. Additional components are also possible. For example, in some embodiments only one of communication block 1130 or proxy 1140 may be included.

The control logic 1110 is configured to provide control and intelligence to the array components. The control logic 1110 may comprise one or more processors, FPGAs, memory units, etc., and direct and control the various data and power communications. The communication block 1130 can direct data communications on a data carrier frequency, such as the base signal clock for clock synchronization. The data communications can be Bluetooth™, WiFi™, ZigBee™, etc., including combinations or variations thereof. Likewise, the proxy 1140 can communicate with clients via data communications as discussed herein. The data communications can be, by way of example and not limitation, Bluetooth™, WiFi™, ZigBee™, etc. Other communication protocols are possible.

In some embodiments, the control logic 1110 can also facilitate and/or otherwise enable data aggregation for Internet of Things (IoT) devices. In some embodiments, wireless power receiver clients can access, track and/or otherwise obtain IoT information about the device in which the wireless power receiver client is embedded and provide that IoT information to the wireless power transmission system over a data connection. This IoT information can be provided to via an external data interface 1115 to a central or cloud-based system (not shown) where the data can be aggregated, processed, etc. For example, the central system can process the data to identify various trends across geographies, wireless power transmission systems, environments, devices, etc. In some embodiments, the aggregated data and or the trend data can be used to improve operation of the devices via remote updates, etc. Alternatively, or additionally, in some embodiments, the aggregated data can be provided to third party data consumers. In this manner, the wireless power transmission system acts as a Gateway or Enabler for the IoT devices. By way of example and not limitation, the IoT information can include capabilities of the device in which the wireless power receiver client is embedded, usage information of the device, power levels of the device, information obtained by the device or the wireless power receiver client itself, e.g., via sensors, etc.

The external power interface 1120 is configured to receive external power and provide the power to various components. In some embodiments, the external power interface 1120 may be configured to receive a standard external 24 Volt power supply. In other embodiments, the external power interface can be, for example, 120/240 Volt alternating current (AC) mains to an embedded direct current (DC) power supply that sources the required 12/24/48 Volt DC to provide the power to various components. Alternatively, the external power interface could be a DC supply that sources the required 12/24/48 Volts DC. Alternative configurations are also possible.

In operation, the MBC, which controls the wireless power transmission system, receives power from a power source and is activated. The MBC then activates proxy antenna elements on the wireless power transmission system and the proxy antenna elements enter a default “discovery” mode to identify available wireless receiver clients within range of the wireless power transmission system. When a client is found, the antenna elements on the wireless power transmission system power on, enumerate, and (optionally) calibrate.

The MBC then generates beacon transmission scheduling information and power transmission scheduling information during a scheduling process. The scheduling process includes selection of power receiver clients. For example, the MBC can select power receiver clients for power transmission and generate a BBS cycle and a Power Schedule (PS) for the selected wireless power receiver clients. As discussed herein, the power receiver clients can be selected based on their corresponding properties and/or requirements.

In some embodiments, the MBC can also identify and/or otherwise select available clients that will have their status queried in the Client Query Table (CQT). Clients that are placed in the CQT are those on “standby”, e.g., not receiving a charge. The BBS and PS are calculated based on vital information about the clients such as, for example, battery status, current activity/usage, how much longer the client has until it runs out of power, priority in terms of usage, etc.

The Proxy Antenna Element (AE) broadcasts the BBS to all clients. As discussed herein, the BBS indicates when each client should send a beacon. Likewise, the PS indicates when and to which clients the array should send power to and when clients should listen for wireless power. Each client starts broadcasting its beacon and receiving power from the array per the BBS and PS. The Proxy AE can concurrently query the Client Query Table to check the status of other available clients. In some embodiments, a client can only exist in the BBS or the CQT (e.g., waitlist), but not in both. The information collected in the previous step continuously and/or periodically updates the BBS cycle and/or the PS.

FIG. 12 is a block diagram illustrating example components of a wireless power receiver client 1200, in accordance with some embodiments. As illustrated in the example of FIG. 12, the wireless power receiver client 1200 includes control logic 1210, battery 1220, an IoT control module 1225, communication block 1230 and associated antenna 1270, power meter 1240, rectifier 1250, a combiner 1255, beacon signal generator 1260, beacon coding unit 1262 and an associated antenna 1280, and switch 1265 connecting the rectifier 1250 or the beacon signal generator 1260 to one or more associated antennas 1290a-n. Some or all of the components can be omitted in some embodiments. For example, in some embodiments, the wireless power receiver client 1200 does not include its own antennas but instead utilizes and/or otherwise shares one or more antennas (e.g., WiFi antenna) of the wireless device, e.g., example device 301, 401, etc., in which the wireless power receiver client is embedded. Moreover, in some embodiments, the wireless power receiver client may include a single antenna that provides data transmission functionality as well as power/data reception functionality. Additional components are also possible.

A combiner 1255 receives and combines the received power transmission signals from the power transmitter in the event that the receiver 1200 has more than one antenna. The combiner can be any combiner or divider circuit that is configured to achieve isolation between the output ports while maintaining a matched condition. For example, the combiner 1255 can be a Wilkinson Power Divider circuit. The rectifier 1250 receives the combined power transmission signal from the combiner 1255, if present, which is fed through the power meter 1240 to the battery 1220 for charging. In other embodiments, each antenna's power path can have its own rectifier 1250 and the DC power out of the rectifiers is combined prior to feeding the power meter 1240. The power meter 1240 can measure the received power signal strength and provides the control logic 1210 with this measurement.

Battery 1220 can include protection circuitry and/or monitoring functions. Additionally, the battery 1220 can include one or more features, including, but not limited to, current limiting, temperature protection, over/under voltage alerts and protection, and coulomb monitoring.

The control logic 1210 receives and processes the battery power level from the battery 1220 itself. The control logic 1210 may also transmit/receive via the communication block 1230 a data signal on a data carrier frequency, such as the base signal clock for clock synchronization. The beacon signal generator 1260 generates the beacon signal, or calibration signal, transmits the beacon signal using either the antenna 1280 or 1290 after the beacon signal is encoded.

It may be noted that, although the battery 1220 is shown as charged by, and providing power to, the wireless power receiver client 1200, the receiver may also receive its power directly from the rectifier 1250. This may be in addition to the rectifier 1250 providing charging current to the battery 1220, or in lieu of providing charging. Also, it may be noted that the use of multiple antennas is one example of implementation and the structure may be reduced to one shared antenna.

In some embodiments, the control logic 1210 and/or the IoT control module 1225 can communicate with and/or otherwise derive IoT information from the device in which the wireless power receiver client 1200 is embedded. Although not shown, in some embodiments, the wireless power receiver client 1200 can have one or more data connections (wired or wireless) with the device in which the wireless power receiver client 1200 is embedded over which IoT information can be obtained. Alternatively, or additionally, IoT information can be determined and/or inferred by the wireless power receiver client 1200, e.g., via one or more sensors. As discussed above, the IoT information can include, but is not limited to, information about the capabilities of the device in which the wireless power receiver client 1200 is embedded, usage information of the device in which the wireless power receiver client 1200 is embedded, power levels of the battery or batteries of the device in which the wireless power receiver client 1200 is embedded, and/or information obtained or inferred by the device in which the wireless power receiver client is embedded or the wireless power receiver client itself, e.g., via sensors, etc.

In some embodiments, a client identifier (ID) module 1215 stores a client ID that can uniquely identify the wireless power receiver client 1200 in a wireless power delivery environment. For example, the ID can be transmitted to one or more wireless power transmission systems when communication is established. In some embodiments, wireless power receiver clients may also be able to receive and identify other wireless power receiver clients in a wireless power delivery environment based on the client ID.

An optional motion sensor 1295 can detect motion and signal the control logic 1210 to act accordingly. For example, a device receiving power may integrate motion detection mechanisms such as accelerometers or equivalent mechanisms to detect motion. Once the device detects that it is in motion, it may be assumed that it is being handled by a user, and would trigger a signal to the array to either to stop transmitting power, or to lower the power transmitted to the device. In some embodiments, when a device is used in a moving environment like a car, train or plane, the power might only be transmitted intermittently or at a reduced level unless the device is critically low on power.

FIG. 13A and FIG. 13B depict diagrams illustrating an example multipath wireless power delivery environment 1300, according to some embodiments. The multipath wireless power delivery environment 1300 includes a user operating a wireless device, e.g., example device 301, 401, etc., including one or more wireless power receiver clients (e.g., 1303). The wireless device 1302 can be example device 301, 401, etc., and the one or more wireless power receiver clients 1303 can be the wireless power receiver client 903 or the wireless power receiver client 1200, although alternative configurations are possible Likewise, wireless power transmission system 1301 can be wireless power transmission system 901 or wireless power transmission system 1100, although alternative configurations are possible. The multipath wireless power delivery environment 1300 includes reflective objects 1306 and various absorptive objects, e.g., users, or humans, furniture, etc.

Wireless device 1302 includes one or more antennas (or transceivers) that have a radiation and reception pattern 1310 in three-dimensional space proximate to the wireless device 1302. The one or more antennas (or transceivers) can be wholly or partially included as part of the wireless device 1302 and/or the wireless power receiver client (not shown). For example, in some embodiments one or more antennas, e.g., WiFi, Bluetooth, etc. of the wireless device 1302 can be utilized and/or otherwise shared for wireless power reception. As shown in the examples of FIG. 13A and FIG. 13B, the radiation and reception pattern 1310 comprises a lobe pattern with a primary lobe and multiple side lobes. Other patterns are also possible.

The wireless device 1302 transmits a beacon (or calibration) signal over multiple paths to the wireless power transmission system 1301. As discussed herein, the wireless device 1302 transmits the beacon in the direction of the radiation and reception pattern 1310 such that the strength of the received beacon signal by the wireless power transmission system, e.g., received signal strength indication (RSSI), depends on the radiation and reception pattern 1310. For example, beacon signals are not transmitted where there are nulls in the radiation and reception pattern 1310 and beacon signals are the strongest at the peaks in the radiation and reception pattern 1310, e.g., peak of the primary lobe. As shown in the example of FIG. 13A, the wireless device 1302 transmits beacon signals over five paths P1-P5. Paths P4 and P5 are blocked by reflective and/or absorptive object 1306. The wireless power transmission system 1301 receives beacon signals of increasing strengths via paths P1-P3. The bolder lines indicate stronger signals. In some embodiments, the beacon signals are directionally transmitted in this manner, for example, to avoid unnecessary RF energy exposure to the user.

A fundamental property of antennas is that the receiving pattern (sensitivity as a function of direction) of an antenna when used for receiving is identical to the far-field radiation pattern of the antenna when used for transmitting. This is a consequence of the reciprocity theorem in electromagnetism. As shown in the example of FIG. 13A and FIG. 13B, the radiation and reception pattern 1310 is a three-dimensional lobe shape. However, the radiation and reception pattern 1310 can be any number of shapes depending on the type or types, e.g., horn antennas, simple vertical antenna, etc. used in the antenna design. For example, the radiation and reception pattern 1310 can comprise various directive patterns. Any number of different antenna radiation and reception patterns are possible for each of multiple client devices in a wireless power delivery environment.

Referring again to FIG. 13A, the wireless power transmission system 1301 receives the beacon (or calibration) signal via multiple paths P1-P3 at multiple antennas or transceivers. As shown, paths P2 and P3 are direct line of sight paths while path P1 is a non-line of sight path. Once the beacon (or calibration) signal is received by the wireless power transmission system 1301, the power transmission system 1301 processes the beacon (or calibration) signal to determine one or more receive characteristics of the beacon signal at each of the multiple antennas. For example, among other operations, the wireless power transmission system 1301 can measure the phases at which the beacon signal is received at each of the multiple antennas or transceivers.

The wireless power transmission system 1301 processes the one or more receive characteristics of the beacon signal at each of the multiple antennas to determine or measure one or more wireless power transmit characteristics for each of the multiple RF transceivers based on the one or more receive characteristics of the beacon (or calibration) signal as measured at the corresponding antenna or transceiver. By way of example and not limitation, the wireless power transmit characteristics can include phase settings for each antenna or transceiver, transmission power settings, etc.

As discussed herein, the wireless power transmission system 1301 determines the wireless power transmit characteristics such that, once the antennas or transceivers are configured, the multiple antennas or transceivers are operable to transit a wireless power signal that matches the client radiation and reception pattern in the three-dimensional space proximate to the client device. FIG. 13B illustrates the wireless power transmission system 1301 transmitting wireless power via paths P1-P3 to the wireless device 1302. Advantageously, as discussed herein, the wireless power signal matches the client radiation and reception pattern 1310 in the three-dimensional space proximate to the client device. Said another way, the wireless power transmission system will transmit the wireless power signals in the direction in which the wireless power receiver has maximum gain, e.g., will receive the most wireless power. As a result, no signals are sent in directions in which the wireless power receiver cannot receive power, e.g., nulls and blockages. In some embodiments, the wireless power transmission system 1301 measures the RSSI of the received beacon signal and if the beacon is less than a threshold value, the wireless power transmission system will not send wireless power over that path.

The three paths shown in the examples of FIG. 13A and FIG. 13B are illustrated for simplicity, it is appreciated that any number of paths can be utilized for transmitting power to the wireless device 1302 depending on, among other factors, reflective and absorptive objects in the wireless power delivery environment. Although the example of FIG. 13A illustrates transmitting a beacon (or calibration) signal in the direction of the radiation and reception pattern 1310, it is appreciated that, in some embodiments, beacon signals can alternatively or additionally be omni-directionally transmitted.

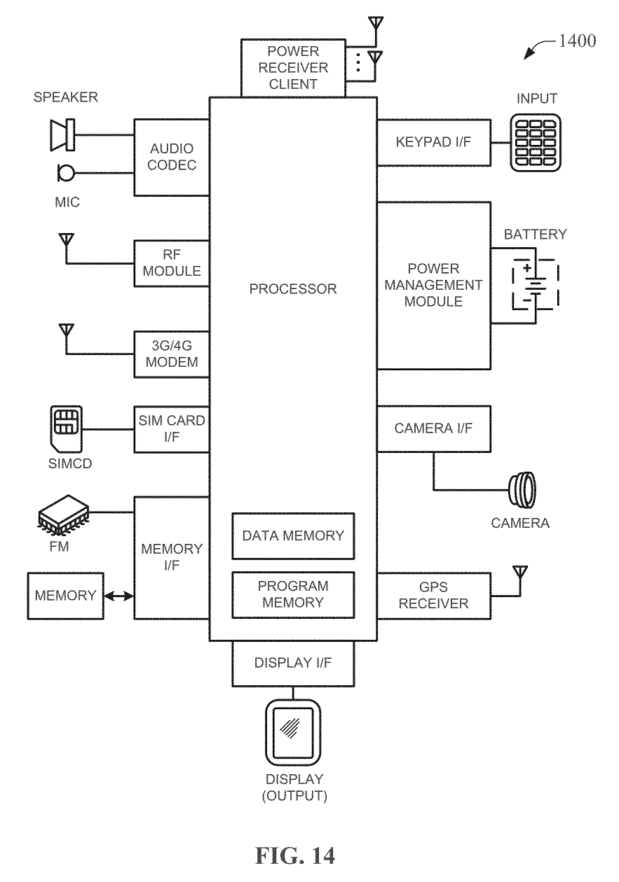

FIG. 14 depicts a block diagram illustrating example components of a representative mobile device, e.g., example device 301, 401, etc., or tablet computer 1400 with a wireless power receiver or client in the form of a mobile (or smart) phone or tablet computer device, according to an embodiment. Various interfaces and modules are shown with reference to FIG. 14, however, the mobile device or tablet computer does not require all of modules or functions for performing the functionality described herein. It is appreciated that, in many embodiments, various components are not included and/or necessary for operation of the category controller. For example, components such as GPS radios, cellular radios, and accelerometers may not be included in the controllers to reduce costs and/or complexity. Additionally, components such as ZigBee radios and RF identification (RFID) transceivers, along with antennas, can populate a PCB.

The wireless power receiver client can be a power receiver client 903 of FIG. 9, although alternative configurations are possible. Additionally, the wireless power receiver client can include one or more RF antennas for reception of power and/or data signals from a charger, e.g., WPTS 901 of FIG. 9.

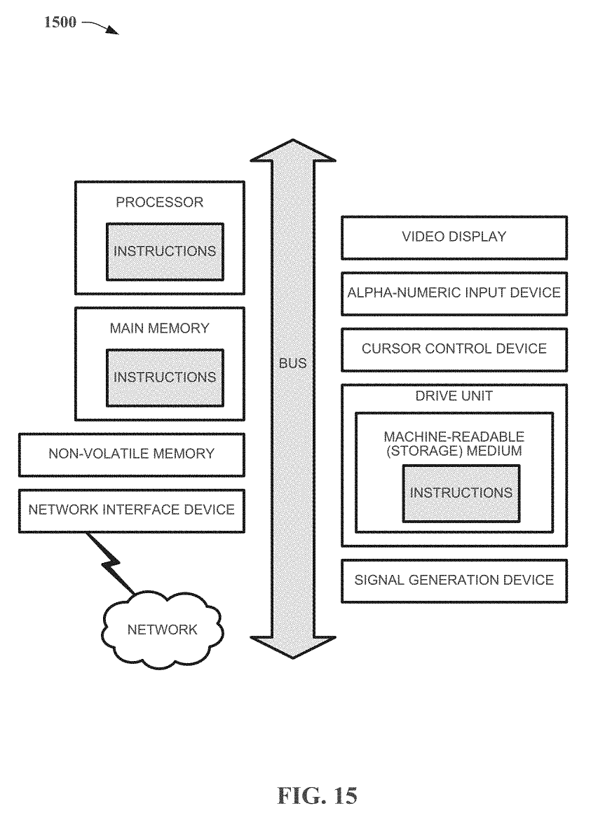

FIG. 15 depicts a diagrammatic representation of a machine, in the example form, of a computer system within which a set of instructions, for causing the machine to perform any one or more of the methodologies discussed herein, may be executed.

In the example of FIG. 15, the computer system includes a processor, memory, non-volatile memory, and an interface device. Various common components (e.g., cache memory) are omitted for illustrative simplicity. The computer system 1500 is intended to illustrate a hardware device on which any of the components depicted in the example of FIG. 9 (and any other components described in this specification) can be implemented. For example, the computer system can be any radiating object or antenna array system. The computer system can be of any applicable known or convenient type. The components of the computer system can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a compact disk ROM (CD-ROM), electrically programmable ROM (EPROM), or electrically erasable ROM (EEPROM), a magnetic or optical card, or another form of storage for large amounts of data. Some of this data is often written, by a direct memory access process, into memory during execution of software in the computer 1500. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, an integrated services digital network (ISDN) modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 15 reside in the interface.

In operation, the computer system 1500 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. Additionally, a processing component can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. A processing component can exploit nano-scale architectures such as, but not limited to, molecular and quantum-dot based transistors, switches and gates, in order to optimize space usage or enhance performance of components described herein. Further, a processing component can also be implemented as a combination of computing processing units.

In the subject specification, term “memory component” and substantially any other information storage component relevant to operation and functionality of a component and/or process described herein, refer to entities embodied in a “memory,” or components comprising the memory. It will be appreciated that a memory component described herein can be either volatile memory or nonvolatile memory, or can include both volatile and nonvolatile memory.

By way of illustration, and not limitation, nonvolatile memory, for example, can be included in ROM, programmable ROM (PROM), EPROM, EPROM, or flash memory. Volatile memory can include RAM, which acts as external cache memory. By way of illustration and not limitation, RAM is available in many forms such as SRAM, DRAM, synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is typically intended to mean an inclusive “or” rather than an exclusive “or.” That is, unless specified otherwise, or clear from context, “X employs A or B” is intended to mean any of the natural inclusive permutations. That is, if X employs A alone, X employs B alone, X employs C alone, X employs A and B alone, X employs B and C alone, X employs A and C alone, or X employs A and B and C, then “X employs A, B or C” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A but not aspect B, and a second embodiment that has aspect B but not aspect A, does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Further, the term “include,” “has,” “contains,” or other similar terms, are intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As used herein, the terms “connected,” “coupled,” or any variant thereof, means any connection or coupling, either direct or indirect, between two or more elements; the coupling of connection between the elements can be physical, logical, or a combination thereof. Where context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are, at times, shown as being performed in a series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Furthermore, embodiments can be combined, elements of embodiments can be excluded, etc. In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A device, comprising:
a processor; and
a memory that stores executable instructions that, when executed by the processor, facilitate performance of operations, comprising:
determining a proximity of an object to a region associated with receiving a transmission of wireless power; and
communicating information related to modifying the transmission of the wireless power to the region based on the proximity of the object to the region.

2. The device of claim 1, wherein the object is selected from a first group comprising human living tissue and non-human living tissue.

3. The device of claim 2, wherein the human living tissue is selected from a second group that comprises at least a portion of a human head, at least a portion of a human torso, and at least a portion of a human limb.

4. The device of claim 3, wherein the information related to the modifying the transmission of the wireless power is a first information corresponding to at least the portion of the human head, a second information corresponding to at least the portion of the human torso, and third information corresponding to at least the portion of the human limb, and wherein the first information, the second information, and the third information each comprise a different indication corresponding to different modifications of the transmission of the wireless power to the region.

5. The device of claim 1, wherein the determining the proximity comprises determining a spatial relationship between the object and a power receiver.

6. The device of claim 1, wherein the determining the proximity comprises determining a spatial relationship between the object and a determined edge of the region associated with the receiving the wireless power transmission.

7. The device of claim 1, wherein the region is approximated by a spherical volume.

8. The device of claim 1, wherein the region is approximated by one or more lobe-shaped volumes in a three-dimensional space.

9. The device of claim 1, wherein the information related to the modifying the transmission of the wireless power comprises an indicator corresponding to suspending the transmission of the wireless power, initiating the transmission of the wireless power, reducing the transmission of the wireless power, or increasing the transmission of the wireless power.

10. The device of claim 1, wherein the information related to the modifying the transmission of the wireless power comprises an indicator corresponding to altering a distribution of energy within the region.

11. The device of claim 1, wherein the communicating the information related to modifying the transmission of the wireless power is further based on a determined characteristic of the object, and wherein the characteristic of the object is related to a level of safe exposure to energy associated with the receiving the transmission of the wireless power.

12. A method, comprising:
receiving, by a system comprising a processor and a memory, first sensor information from a first sensor device, wherein the first sensor information comprises an indication of a presence of an object proximate to a region associated with receiving a transmission of wireless power;
determining, by the system, a proximity of the object to the region based on the first sensor information; and
indicating, by the system, a modification to the transmission of the wireless power based on the proximity of the object to the region.

13. The method of claim 12, further comprising, receiving, by the system, second sensor information from a second sensor device, wherein the second sensor information comprises an indication of a characteristic of the object, and wherein the indicating the modification to the transmission of the wireless power is further based on the characteristic of the object.

14. The method of claim 13, wherein the receiving the second sensor information indicates that the object is living tissue based on the indication of the characteristic of the object.

15. The method of claim 13, wherein the receiving the second sensor information indicates that the object is a portion of a human head or a portion of the human body other than the human head based on the indication of the characteristic of the object, wherein the indicating the modification of the transmission of the wireless power corresponds to a first modification in response to the second sensor information indicating that the object is the portion of the human head, and wherein the indicating the modification of the transmission of the wireless power corresponds to a second modification, different from the first modification, in response to the second sensor information indicating that the object is the portion of the human body other than the human head.

16. The method of claim 13, wherein the receiving the second sensor information indicates that the object is not living tissue based on the indication of the characteristic of the object.

17. A machine-readable storage medium, comprising executable instructions that, when executed by a processor, facilitate performance of operations, comprising:
in response to receiving first sensor information from a first sensor device, determining a proximity of an object to a region associated with receiving a transmission of wireless power based on the first sensor information;
in response to receiving second sensor information from a second sensor device, determining a characteristic of the object based on the second sensor information; and
enabling a modification to the transmission of the wireless power based on the proximity of the object to the region and based on the characteristic of the object.

18. The machine-readable storage medium of claim 17, wherein the characteristic of the object is indicative of the object comprising human living tissue, non-human living tissue, or an object other than tissue.

19. The machine-readable storage medium of claim 17, wherein the enabling the modification comprises enabling suspending the transmission of the wireless power, initiating the transmission of the wireless power, reducing the transmission of the wireless power, increasing the transmission of the wireless power, or modifying the distribution of the wireless power.

20. The machine-readable storage medium of claim 17, wherein the enabling the modification is further based on a determined acceptable level of energy exposure related to the object.
